(19) United States
(12) Patent Application Publication
(10) Pub. No.: US 2005/0252084 A1
(43) Pub. Date: Nov. 17, 2005

(54) Garage door sealing member

(76) Inventor: Perry Antoshak, Forestburgh, NY (US)

Correspondence Address: Michael E. Zall, Two Yorkshire Drive, Suffern, NY, 10901, US

(21) Appl. No.: 10/844,015

(22) Filed: May 13, 2004

(51) Int. Cl. E06B 7/00

(52) U.S. Cl. 49/70

(57) ABSTRACT

A garage door sealing member used for installation on a garage door along a bottom edge that contacts a floor when the garage door is closed. The sealing member is an elongated, polymeric member having and a length at least equal to the length of the bottom edge of the garage door. The sealing member has a slit along the length thereof to form adjacent edges along the length of the sealing member. The adjacent edges are resiliently separable to permit the slit to be widened to at least the thickness of the bottom edge of the garage door to thereby permit the bottom edge to pass therethrough. The sealing member encloses the length of the bottom edge of the garage door, the adjacent edges of the sealing member springably and/or frictionally gripping the length of the bottom edge. Thus when the door is closed the outer wall of the sealing member and floor form a seal. Preferably the hollow member is hollow and substantially cylindrical. The elongated member is preferably in a spiral configuration suitable for easy packaging, shipping, storage prior to use.

### BACKGROUND OF THE INVENTION

1. Field of the Invention

This invention relates to a garage door sealing member, and in particular to a garage door sealing member that can be inexpensively produced and packaged and subsequently installed on the bottom of a garage door and provides excellent sealing between the bottom of the garage door and the floor.

2. Description of the Related Art

Known garage door sealing members are often difficult and time consuming to install, either requiring installation on tracks on the garage door or nailing them to the bottom of the garage door.

The following references are to a greater or lesser degree are relevant to the invention herein:

U.S. patent application Ser. No. 2003/0159380 to Doucet, S R., et al. (Pub. Date Aug. 28, 2003) describes a device used to cover the breaks or holes in exterior vinyl or other type of siding on the exterior corners of buildings. The corner repair and protector is a one-piece unit shaped like the corner of a building and has edges formed to snap it onto the existing siding to hold it securely in place. It has tabs on the bottom, which cover any openings between the existing siding and the structure to which it is attached for purposes of keeping out wind, small animals, and birds.

U.S. Ser. No. 2003/0126826 to Marshall et al. (Pub. Date Jul. 10, 2003) describes a hinged protective cover for protecting a door threshold during construction or modification of a building or its contents. The cover is attached to a horizontal surface such as a building floor and covers the door threshold to prevent damage from foot traffic, contaminants and grit materials which may become lodged in the threshold. The hinge allows positioning of the protective cover to permit door closure while remaining attached to the floor.

U.S. patent application Ser. No. 2002/0194810 to Conachen (Pub. Date Dec. 26, 2002) describes an extruded or molded plastic covers snap fit into the jamb liner slots over the lower jamb liners. Replaceable brush weatherstrips on the edge contact the lower window sash. Upper foam pads engage the upper window sash and press the upper sash against the window frame.

U.S. Ser. No. 2002/0166305 to Weller (Pub. Date Nov. 14, 2002) describes a protective cylindrical sleeve for the metal corners of recreational vehicle slide-outs. The sleeve can be made out of a solid or composite material.

U.S. application Ser. No. 2002/0112444 to Lacesse (Pub. Date Aug. 22, 2002) describes, in relevant part, a garage door having a capping member fitted with a resilient semi-circular strip that serves as a bumper or edge protector when the door approaches the floor.

U.S. Pat. No. 6,609,349 to Davidsaver describes a window framing system which uses corner keys, and which seal against embossed surfaces, particularly for use in garage doors.

U.S. Pat. No. 6,357,187 to Haldeman describes a device for protecting the edge of a doorway. The device includes opposing contact edges which extend around the edge of a doorway to contact and grip opposing walls adjacent the doorway. The edge of the doorway, which may include a door frame, is enclosed within a protective space defined by the device. Alternatively, the device may be mounted on a doorway and an attached door so that both the edge of the doorway and a portion of the door are enclosed within a protective space defined by the device. The device may be modified in the field to fit doorways and/or doors of various sizes.

U.S. Pat. No. 6,052,957 to Minnich describes resilient compressible edge inserts for insertion into window frames where they are held in place and form a seal with the frames as a result of compression of a compressible, resilient edge material.

U.S. Pat. No. 5,901,516 to Watson describes a spacer and tension clip for mounting a baseboard of a wall so that the baseboard can be easily removed and then remounted to the wall.

U.S. Pat. No. 5,815,998 to Wamsher describes a doorjamb protector apparatus that includes resilient flexible clamp portions in a form of a unified, integrated structure that is substantially U-shaped.

### OBJECTS AND SUMMARY OF INVENTION

It is an object of this invention to provide an inexpensively-manufactured, low-retail-cost garage door sealing member.

It is yet another object of this invention to provide a garage door sealing member that is also easy to package for storage, shipment and sales to consumers.

It is still another object of this invention is to provide a garage door sealing member that is easy to install.

It is another object of this invention is to provide a garage door sealing member that is effective to seal the outside of the garage from the inside of the garage when the door is closed.

All of the foregoing objects as well as others are achieved by the garage door sealing member of this invention. The sealing member is used for installation on a garage door along a bottom edge that contacts a floor when the garage door is closed. The sealing member comprises an elongated, preferably hollow cylindrical polymeric member having an inner wall and an outer wall and a length at least about equal to the length of the bottom edge of the garage door. The sealing member has a slit along the length thereof that passes through the inner and outer walls to form adjacent edges along the length of the sealing member. The adjacent edges are resiliently separable to permit the slit to be widened to at least the thickness of the bottom edge of the garage door to thereby permit the bottom edge to pass therethrough. The sealing member encloses the length of the bottom edge of the garage door, the adjacent edges of the sealing member springably gripping the length of the bottom edge. Thus when the door is closed the outer wall of the sealing member and floor form a seal. The elongated member is preferably in a spiral configuration suitable for easy packaging, shipping, storage.

The foregoing is a description of the invention and some of its optional aspects. The invention may be further understood by the description of the preferred embodiments, in conjunction with the drawings, which now follow.

### BRIEF DESCRIPTION OF THE DRAWINGS

For a more complete understanding of the present invention, reference may be had to the following description of exemplary embodiments of the present invention considered in connection with the accompanying drawings, of which:

FIG. 1 is a perspective view of one embodiment of the garage door sealing member;

FIG. 2 is a cross-sectional view of the garage door sealing member shown in FIG. 1;

FIG. 3 is a cross-sectional view of the garage door sealing member shown in FIG. 1 in use on a garage door taken along line 3-3 of FIG. 4;

FIG. 4 is a schematic side view of the garage door sealing member shown in FIG. 1 in use on a garage door; and

FIG. 5 is a top view of the garage door sealing member shown in FIG. 1, wound in a coiled configuration.

### DETAILED DESCRIPTION OF THE INVENTION

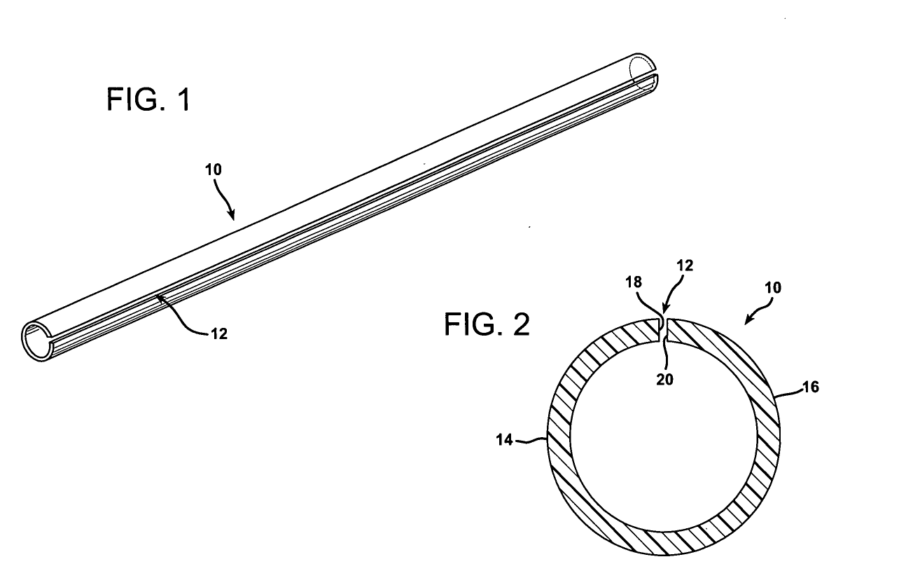

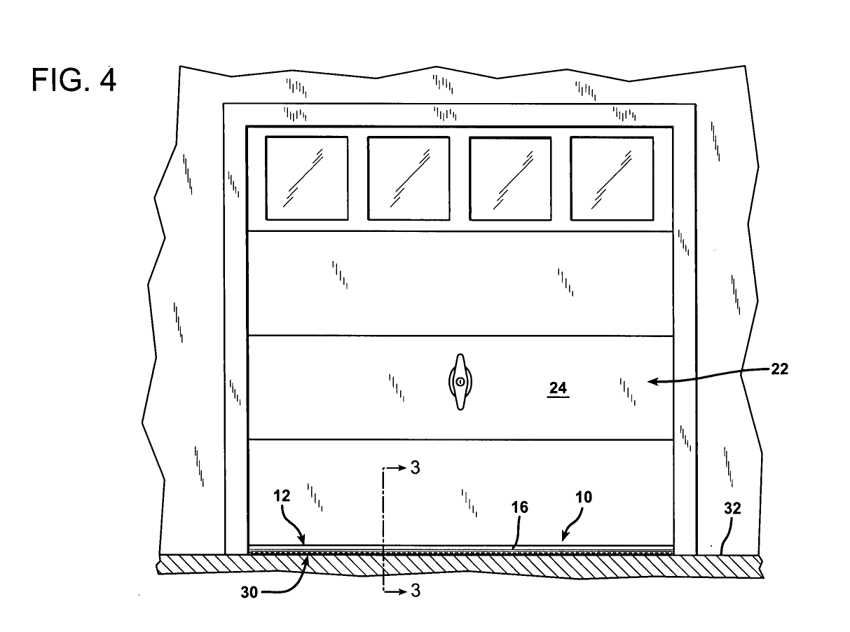

Referring to FIGS. 1-5, the garage door sealing member 10 is installed on a garage door 22 along a bottom edge 28 that contacts a floor 32 at contact area 30 when the garage door 22 is closed. The bottom edge 28 of the garage door has a specified length and thickness.

The sealing member 10 is an elongated, preferably hollow polymeric member having an inner wall and an outer wall and a length at least about equal to the length of the bottom edge of the garage door 22. Preferably the hollow member 10 is substantially cylindrical or tubular. Although many shapes are possible, in the preferred embodiment, sealing member 10 is shaped as an elongate, slotted cylinder having a substantially circular or C-shaped cross-section as viewed along its elongate axis. The interior of the cylinder is hollow. Opposing edges 18 and 20 are spaced apart to form slit 12 creating an inner side 14 and an outer side 14. The width of slot 12 is less than the thickness of the garage door edge 28. While shown as a tubular, resilient, partial cylindrical member in FIGS. 1-3, this sealing member 10 may also be in the form of U shaped resilient strips or a u-shaped solid foamed material (not shown).

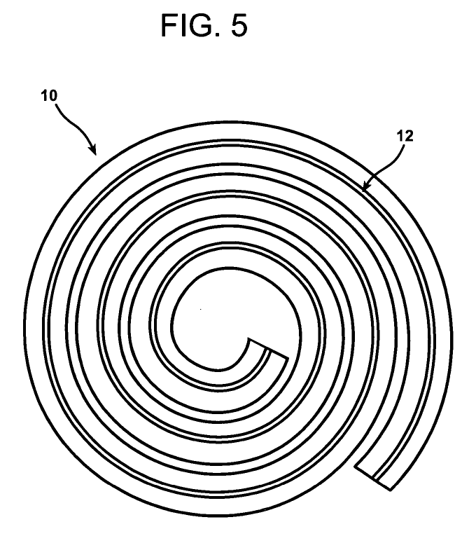

The sealing member 10 can be made out of a solid or composite material. By use of a compliant material for the sealing member 10, the sealing member may be compressed between the bottom edge 28 and floor 32 at the contact area 30. The material may be a rubber, plastic or like material and maybe in a flexible, resilient, and compressible sponge-like form. One suitable material for use with this invention is a foamed plastic such as is used to prevent moisture condensation on cold water pipes, e.g., closed-cell polyethylene (PE) pipe covering. However, it is most preferred to use a more flexible type material, e.g., PVC, that can be wound into a spiral or coil configuration as depicted in FIG. 5. The sealing member material 10 should have sufficient resiliency and compressibility to return to its original shape after the application of both bending and compression forces.

The sealing member 10 is in lengths sufficient to extend the length of the garage door edge 28, preferably in a single piece. The cross-section of the sealing member 10 can be of any shape with a circular shape being typical. When the sealing member 10 has a solid (filled) circular cross-section (not shown), the sealing member takes on the shape of a solid cylinder or rod. However, it is more preferred to have a hollow opening formed in the interior sealing member 10 as depicted in FIGS. 1-3 that extends the length of the material.

Referring to the embodiment depicted in FIGS. 1-3, the sealing member 10 has a slit 12 along the length thereof that passes through the inner and outer walls to form adjacent edges 18, 20 along the length of the sealing member 10. The adjacent edges 18, 20 are resiliently separable to permit the slit 12 to be widened to at least the thickness of the bottom edge 28 of the garage door 22 to thereby permit the bottom edge 28 to pass therethrough. On release of the opening force the resilient character of the sealing member 10 bottom edge 28 to provide a clamping and sealing effect around the garage door edge 28. The sealing member 10 encloses the length of the bottom edge 28 of the garage door 22, the adjacent edges 18, 20 of the sealing member 10 springably gripping and/or frictionally engaging the length of the bottom edge 28.

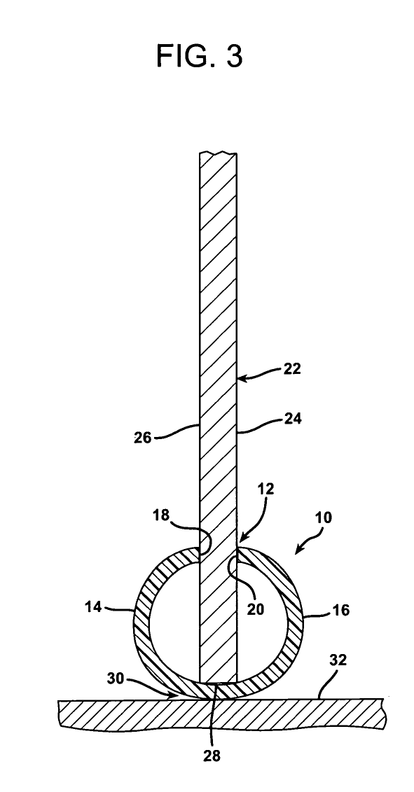

Considerable latitude is allowed in the direction of the slit 12 with respect to the center line or axis of the sealing member 10 with the only requirement being that the slit be coextensive, that is, in the same general lengthwise direction as the longitudinal or lengthwise centerline of the sealing member 10. Slit 12 is not required to pass toward or through the centerline or longitudinal axis of the sealing member 10 but may pass to either side of them. Thus for a circular cross section, slit 12 can extend into the cylindrical solid in a radial direction or the slit can extend into the solid in a direction of a chord of the circle. When sealing member 10 is tubular in shape, i.e., in the shape of an annular cylinder, the longitudinal slit 12 passes completely through the tube or annular cylinder wall, that is, through both the interior and exterior tube surfaces, see FIG. 3. The slit 12 also passes from one end of the cylinder to the other in a direction coextensive with the longitudinal cylinder axis. Thus when the door is closed the outer wall of the sealing member 10 and floor form a seal thereby preventing unwanted air and water leaks between the garage door edge 28 and the floor 32.

The sealing member 10 in its initial configuration is preferably in a spiral configuration, as shown in FIG. 5, suitable for easy packaging, shipping, storage.

It should be appreciated by one skilled in the art that the sealing member 10 may be manufactured in a variety of lengths and widths to accommodate a wide variety of garage doors. Preferred sizes are from 2½ inches to 4½ inches in diameter, and when a hollow cylinder, with a wall thickness of about 1/16 inch. Where necessary, the length of the sealing member 10 may be trimmed using a saw, shears or other cutting means to fit the garage door. A wide variety of commonly available polymeric materials may be used such as polyvinyl chloride (PVC), or even composite fiber materials or lightweight metals, high strength cardboard or aluminum. The preferred materials are flexible polymeric materials. The sealing member 10 can come in any number of colors designed to match or contrast with the garage door.

Installing the sealing member 10 on the garage door is relatively easy. For example, one unwinds the member 10 from its spiral configuration, spreads the edges 18 and 20 apart and places them around the edge 28 at one side of the garage door and then gradually forces the member 10 onto the edge 28 moving toward the other side of the garage door. Closing the garage door several times will set the member 10 in its final position.

The foregoing constitutes a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure.

1. A sealing member for installation on a garage door along a bottom edge that contacts a floor when the garage door is closed, the bottom edge having a length and a thickness, the sealing member comprising:
an elongated member having a length at least about equal to the length of the bottom edge of the garage door;
the sealing member having a slit along the length thereof to form adjacent edges along the length of the sealing member;
the adjacent edges resiliently separable to permit the slit to be widened to at least the thickness of the bottom edge of the garage door to thereby permit the bottom edge to pass therethrough, the sealing member enclosing the length of the bottom edge of the garage door, the adjacent edges of the sealing member springably gripping the length of the bottom edge, whereby when the door is closed the outer wall of the sealing member and floor form a seal.

2. The sealing member of claim 1, wherein the elongated member is in a spiral configuration.

3. The sealing member of claim 1, wherein the sealing member is substantially cylindrical.

4. The sealing member of claim 1, wherein the sealing member is substantially hollow and cylindrical.

5. A sealing member for installation on a garage door along a bottom edge that contacts a floor when the garage door is closed, the bottom edge having a length and a thickness, the sealing member comprising:
an elongated cylindrical, hollow polymeric member having an inner wall and an outer wall and a length at least about equal to the length of the bottom edge of the garage door;
the sealing member having a slit along the length thereof that passes through the inner and outer walls to form adjacent edges along the length of the sealing member;
the adjacent edges resiliently separable to permit the slit to be widened to at least the thickness of the bottom edge of the garage door to thereby permit the bottom edge to pass therethrough, the sealing member enclosing the length of the bottom edge of the garage door, the adjacent edges of the sealing member springably gripping the length of the bottom edge, whereby when the door is closed the outer wall of the sealing member and floor form a seal.

6. A sealing member for installation on a garage door along a bottom edge that contacts a floor when the garage door is closed, the bottom edge having a length and a thickness, the sealing member comprising:
an elongated cylindrical, polymeric foam member and a length at least about equal to the length of the bottom edge of the garage door;
the sealing member having a slit along the length thereof to form adjacent edges along the length of the sealing member;
the adjacent edges resiliently separable to permit the slit to be widened to at least the thickness of the bottom edge of the garage door to thereby permit the bottom edge to pass therethrough, the sealing member enclosing the length of the bottom edge of the garage door, the adjacent edges of the sealing member frictionally gripping the length of the bottom edge, whereby when the door is closed the outer wall of the sealing member and floor form a seal.
